(19) United States
(12) Patent Application Publication
(10) Pub. No.: US 2015/0008087 A1
(43) Pub. Date: Jan. 8, 2015

(54) DRIVE TRANSMISSION PART FOR IMAGE FORMING APPARATUS

(71) Applicant: MITSUBISHI CHEMICAL CORPORATION, Tokyo (JP)

(72) Inventor: Shinichi IIJIMA, Jurong (SG)

(73) Assignee: MITSUBISHI CHEMICAL CORPORATION, Tokyo (JP)

(21) Appl. No.: 14/491,587

(22) Filed: Sep. 19, 2014

Related U.S. Application Data
(62) Division of application No. 13/827,515, filed on Mar. 14, 2013.
(60) Provisional application No. 61/640,365, filed on Apr. 30, 2012.

(51) Int. Cl. F16D 41/00

(52) U.S. Cl. CPC F16D 41/00
USPC 192/45.1

(57) ABSTRACT

Drive transmission part and system including a columnar male part to be engaged with a twisted triangular female part to allow rotation of a part of an image forming apparatus. The columnar male part can include one or more projections of circular or elliptical cross section, arranged in a triangular pattern, or centrally located. The columnar part can also include a threaded surface to engage the female part. An intermediary part can also be provided to connect a ratchet type of part to the female part.

### CROSS-REFERENCE TO RELATED APPLICATIONS

This application is a division of U.S. application Ser. No. 13/827,515 filed Mar. 14, 2013, which is a non-provisional of U.S. Application No. 61/640,365 filed Apr. 30, 2012 the entire contents of each of which are incorporated herein by reference.

### BACKGROUND

1. Field of the Disclosure

This disclosure is drawn to a drive transmission part for an image forming apparatus, which can be used with an organic photo conductor (OPC) drum or other rotating cylindrical part installed or to be installed in an image forming apparatus and/or a toner cartridge. Such an image forming apparatus can be an electro-photographic image forming apparatus, such as a laser, LED or similar type of printer, a facsimile device, or a multi-function document processing device including a printer.

2. Description of the Related Art

U.S. Pat. No. 5,903,803 to Kawai et al. describes a transmission mechanism between a drive member and a driven member, specifically in the context of an OPC-type drum of an imaging cartridge. The drive member and the driven member can be described as male and female shafts or parts. The male part has an equilateral triangular cross-section, which twists, and the female part has a corresponding equilateral triangular cross-sectional shape to accept the male part having the twisting equilateral triangular cross-section. U.S. Pat. No. 5,903,803 to Kawai et al. is incorporated herein in its entirety by reference.

### SUMMARY

According to aspects of this disclosure, a directly corresponding male/female shape is not necessary. Similar and related aspects were discussed in related application U.S. 61/614,346, filed Mar. 22, 2012, application U.S. 61/615,012, filed Mar. 23, 2012, and application U.S. 61/637,078, filed Apr. 23, 2012.

In accordance with aspects of this disclosure, relative to a male part having a twisting equilateral triangular cross-section, instead of a twisting male part being inserted into a correspondingly twisting female part, a male part of a shape different from that of a female part can be inserted into the female part. Aspects of this disclosure relate to a columnar male part being inserted into a triangular twisted female part.

A drive transmission part and system including a columnar male part engaged with a twisted triangular cross-section female part to allow rotation of a cylindrical part of an image forming apparatus can be provided.

A rotating part can be installed in an image forming apparatus. The rotating part can include a drive transmission member including a columnar male part configured to be inserted into a twisted triangular female part. The male part can include a projection having a curved surface to contact an edge of the female part to transmit a torque.

The male part can include a plurality of projections having a circular cross section. The projections having a circular cross section can be arranged in a triangular shape which is a same shape as a triangular shape of a cross section of the female part, and the triangular shape of the projections can smaller than the triangular shape of the cross section of the female part. This same shape can be an equilateral triangle shape.

A metal pin can be provided in each projection to increase strength and/or rigidity.

The male part can include only a single elliptical cross section projection.

The male part can include a screw threaded surface to engage the female part. The screw threaded surface can be provided at a base portion of the male part, and the male part can include a tip portion which is provided to engage a base surface of the female part.

A rotating part installable in an image forming apparatus can include a drive transmission member including a ratchet-type male part configured to be inserted into a twisted triangular female part. The male part can include a plurality of wedges extending from a base surface, and the wedges can be arranged to contact the female part at an edge or surface and not at a point thereof.

The wedges can have respective inner and outer side profiles respectively corresponding to inner and outer radial positions of the rotating part. The inner side profiles can have a larger circumferential dimension relative to the outer side profiles so as to increase an amount of material of the male part engageable with the female part. Each of the wedges can include a contact surface which extends between corresponding edges of the inner and outer side profiles thereof. The contact surface can have a complementary contour to that of a corresponding contact surface of the female part.

The wedges can also have respective inner and outer curved edges corresponding to inner and outer radial positions of the rotating part.

A rotating part installable in an image forming apparatus can include a drive transmission member including a ratchet-type male part configured to be inserted into a twisted triangular female part. The male part can include a plurality of wedges extending from a base surface, and the wedges can have respective inner and outer curved edges corresponding to inner and outer radial positions of the rotating part.

A rotating part can include a cylindrical body including a photoconductor. An imaging cartridge for an image forming apparatus can include the rotating part, and an image forming apparatus can include the imaging cartridge and the twisted triangular female part as a drive member for driving and rotating the rotating part.

The foregoing paragraphs have been provided by way of general introduction. The described embodiments, together with the attendant advantages thereof, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a perspective view of a columnar male part formed by three projections having circular cross sections;

FIG. 2 is an end view of the columnar male part shown in FIG. 1 engaged with a twisted triangular female part;

FIG. 3 is a perspective view of a columnar male part formed by three projections having circular cross sections, where the three projections are metal pins inserted into an end of an OPC drum;

FIG. 4 is an end view of the columnar male part shown in FIG. 3 engaged with a twisted triangular female part;

FIG. 5 is a perspective view of a columnar male part formed by a single projection having an elliptical cross section;

FIG. 6 is an end view of the columnar male part shown in FIG. 5 engaged with a twisted triangular female part;

FIG. 7 is a perspective view of a columnar male part formed by a base projection having a threaded exterior so as to form a screw and a tip projection extending from the base projection;

FIG. 8 is an end view of a twisted triangular female part engageable with the columnar male part shown in FIG. 7;

FIG. 9 is an end view of the columnar male part shown in FIG. 7 engaged with the twisted triangular female part shown in FIG. 8;

FIG. 10 is a perspective view of an intermediary part formed by a prism coupling piece to provide a transmission connection between a twisted triangular female part and an OPC drum;

FIGS. 11A and 11B schematically illustrate how holes can be located within the center of a projection to provide a space for a strength securing member, thereby constraining design space;

FIGS. 12A to 12C schematically illustrate a modification to a ratchet according to U.S. 61/615,012;

FIG. 13 schematically illustrates a further modification to the ratchet according to U.S. 61/615,012; and

FIGS. 14A to 14D schematically illustrate alternative views of the modification shown in FIG. 13.

### DETAILED DESCRIPTION OF THE EMBODIMENTS

In the drawings, like reference numerals or characters, if applicable, designate identical or corresponding parts throughout the several views.

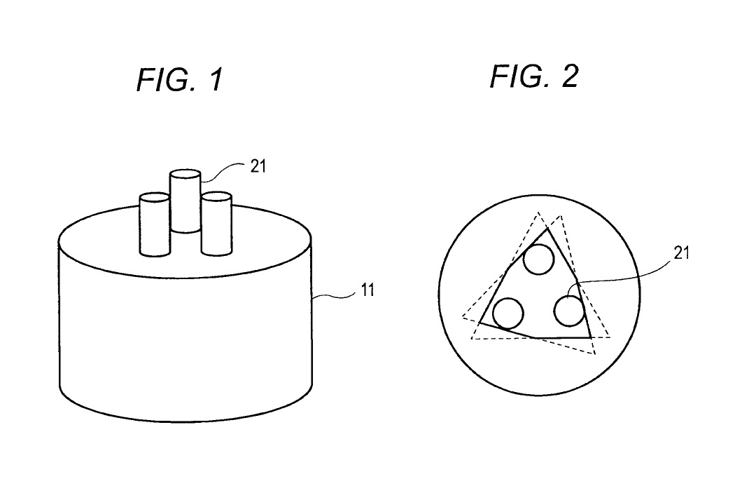

FIG. 1 illustrates an end of an OPC drum 11 having a columnar male part provided by three circular cross section projections 21. These projections 21 may be formed by pins integral with or separate from the end of the OPC drum.

Rotation is provided by engagement of projections 21 within a twisted hole. Various cross section shapes can be used, including circular, ellipsoidal, and polygonal. The three projections 21 can be a frustum of a circular cone and/or a frustum of a pyramid.

As shown in FIG. 2, these projections 21 are aligned so as to correspond to available axial recess shape (here, a hexagonal outline provided by the solid line) in a manner that corresponds to a twisted triangular hole. These projections are shown as a series of three pins. However, other cross sectional shapes, such as quadrilateral and elliptical, can be used. Further, the arrangement of the pins is not necessarily equilateral as shown in FIG. 2. By such an arrangement, a transmission is provided for rotational movement between the twisted triangular female part and the columnar male part. Also, female parts other than a twisted triangular shape may be used.

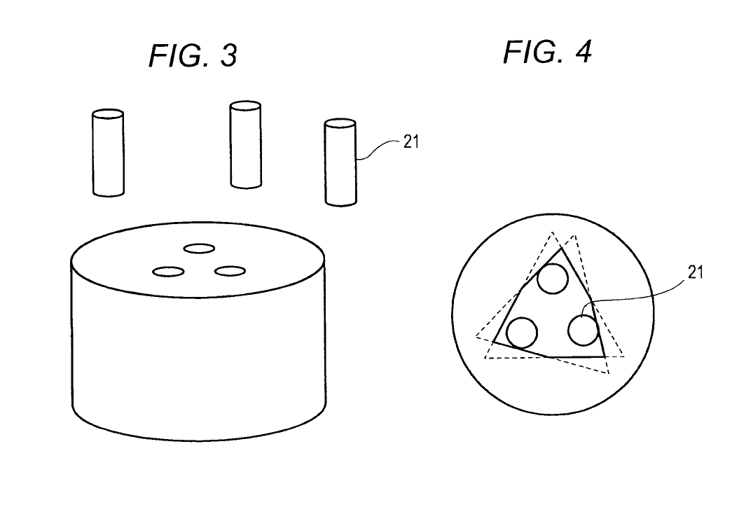

FIGS. 3-4 illustrate a further implementation of that shown in FIGS. 1-2. Here, the three circular cross section projections 21 are metal pins to increase strength of the columnar male part. These metal pins can be recessed into the end of the OPC drum for rigidity and strength of connection.

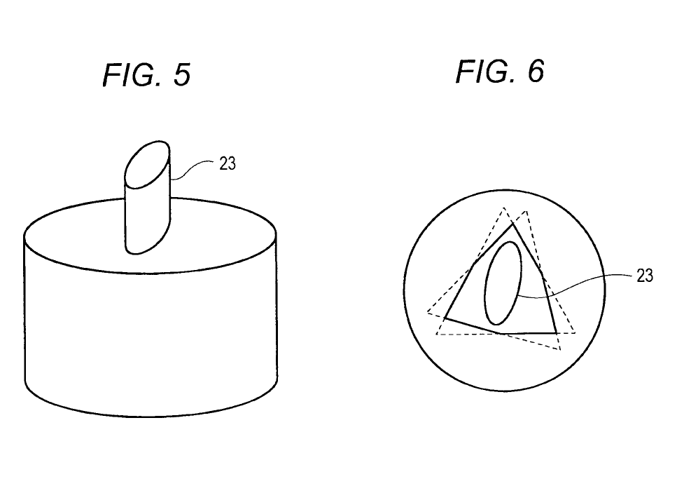

FIGS. 5-6 illustrate an elliptical cross section columnar projection 23, where only one projection is provided. However, with reference to FIG. 1, multiple elliptical cross section projections could be used.

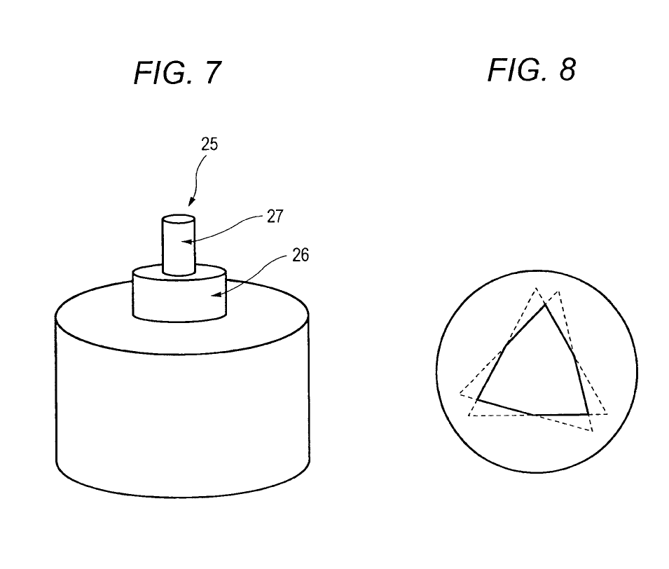

FIG. 7 illustrates a screw type columnar projection 25, formed by a base portion 26 and a tip portion 27. The base portion 26 includes a screw thread. The tip portion 27 extends from the base portion 26 and has a smaller dimension (i.e., a smaller diameter and/or width from an end view so that the smaller dimension does not contact the edges of a twisted triangular female part). FIG. 8 illustrates a twisted triangular female part to be engaged to the screw type columnar projection.

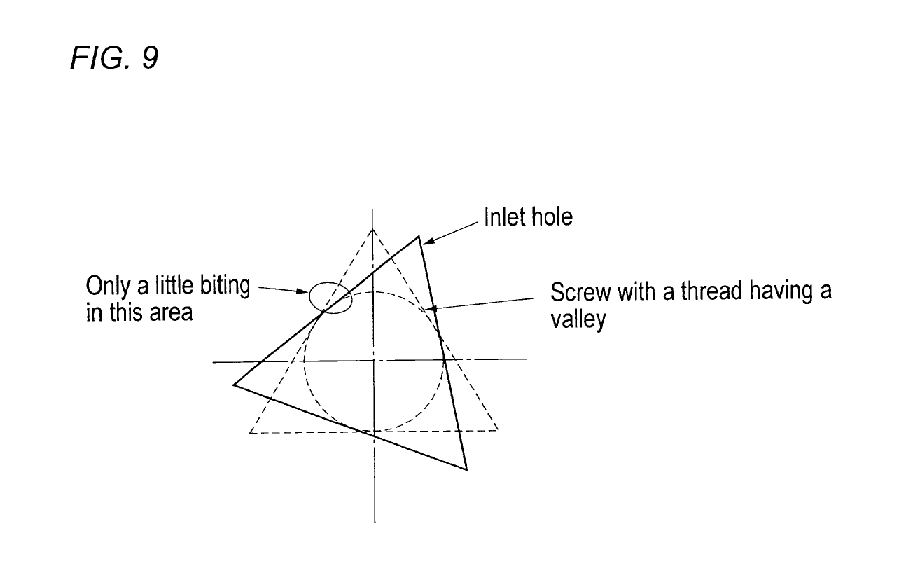

FIG. 9 illustrates the screw type columnar projection engaged to the twisted triangular female part. The screw type columnar projection has a thread with a valley (i.e. a root) which is a little bit smaller than the inscribed circle shown in FIG. 9. Correspondingly, the thread has a crest which is a little bit larger than the inscribed circle shown in FIG. 9. Therefore, a little biting is provided in the encircled area shown in FIG. 9. This biting is also provided at the other two engagement points shown in FIG. 9 (but not encircled). Although not shown, the aforementioned tip portion is a gauge to prevent the screw type columnar projection from being screwed into the female part past a predetermined/designed level. That is, a reliable and determined engagement can be provided when the tip portion reaches (i.e. contacts or engages) a base of the female part.

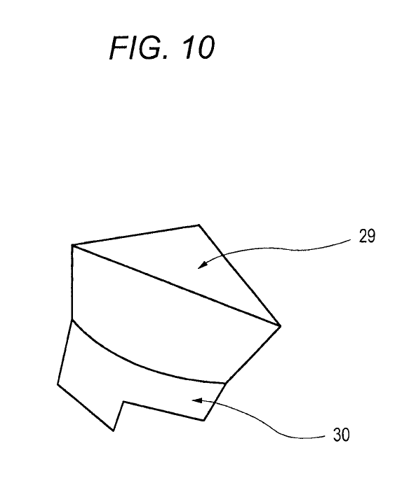

FIG. 10 illustrates another implementation which utilizes an intermediary part between a twisted triangle female part and a male part. Here, this intermediary part has a male end to engage the twisted triangle female part, such as a twisted triangular prism 29 as shown. However, other shapes could be used. Further, the intermediary part can be permanently or semi-permanently engaged to the twisted triangle female part. For such an implementation, press fitting, adhesion or some other coupling can be used.

The other end of the intermediary part includes a ratchet coupling 30. As such, an OPC drum provided with a ratchet type of end coupling can removable engage a twisted triangle female part via the intermediary part, which itself is either permanently or detachably engaged to the twisted triangle female part.

In one implementation according to FIG. 10, the twisted prism portion of the attachment tightly engages with a twisted hole (female part), and an attachment portion facing an OPC drum is of a ratchet type. A gear flange provided at the end of OPC drum has an engageable portion of a ratchet type with the ratchet type portion of the attachment.

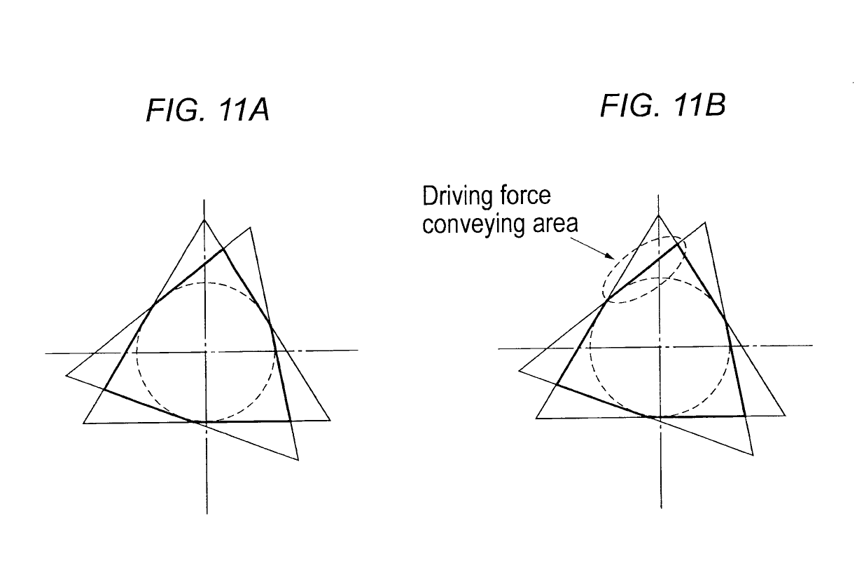

FIGS. 11A and 11B illustrate how holes can be provided within the material (in an axial direction) of a projection. The hole allows for a strengthening member (a strength providing member, which increases longevity of the projection and rigidity thereof) to be inserted therethrough. An exemplary strengthening member is a metal pin.

U.S. 61/615,012 discusses a ratchet type male part formed by wedges.

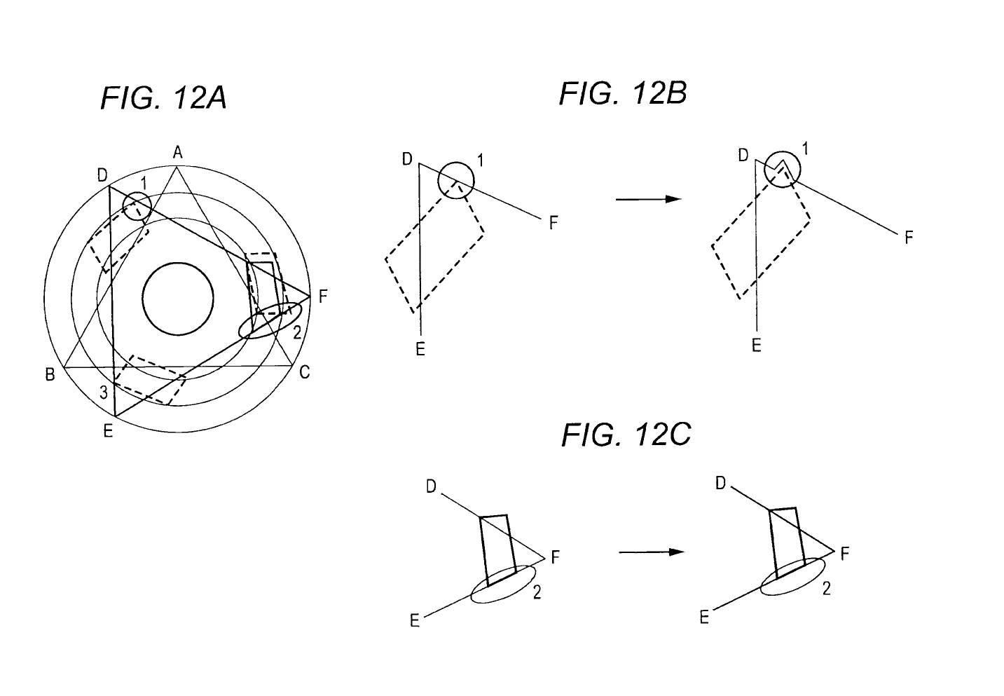

See, e.g., FIGS. 1-2. FIGS. 12A to 12C herein schematically illustrate a modification to the ratchet type male part, specifically a modification to Case 1 and/or 2 of U.S. 61/615,012.

As shown in FIG. 12B, a point contact between a wedge and the female part can cause an indentation/damage to the female part after repetitive motion (e.g., repetitive printing). To limit the amount of damage and/or the possibility of damage, the wedge is modified to contact the female part along a surface or edge -not at a point. As shown in FIG. 12C, the edge/surface contact will not cause damage to the female part as could be caused by the wedge without the modification. Otherwise, the aspects of Cases 1 and/or 2 discussed in U.S. 61/615,012 may be incorporated into this modification.

FIG. 13 schematically illustrates a further modification to the ratchet according to U.S. 61/615,012. Here, the wedges discussed above are aligned in a curved or circular fashion. Another modification can be made which incorporates the modification of FIG. 12 with that of FIG. 13. That is, the wedges have both curved surfaces (inner and outer radial edges with respect to the rotating part) and contact the female part at edges/surfaces—not single points.

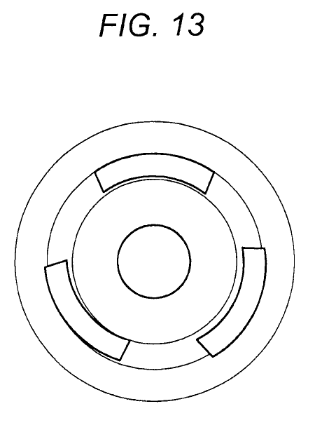

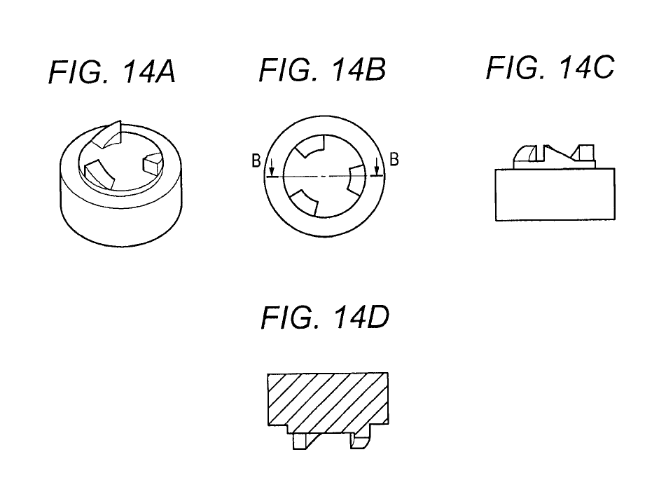

FIGS. 14A to 14D schematically illustrate alternative views of the modification shown in FIG. 13. In particular, a section view taken along line B-B is shown, as well as a continuous profile of the wedges. FIGS. 14A to 14D illustrate the wedges as arranged with 45 degree circumferential lengths, each spaced 120 degrees apart (with respect to respective starting or end points of the wedge). However, it should be appreciated other circumferential lengths and spacing may be used without detracting from the scope of this implementation.

The above-discussed examples relate to an engagement with a twisted-triangular female part/recess. However, the discussed projections can be adapted to engage other recesses, such as tapered recesses and recesses of another prism-type or polygonal shape.

The material of the male part is preferable the same or at least similar to that known in the art for prior male parts. However, as discussed above, strength members (such as metal pins) can be utilized exclusively or as supporting inner members.

In view of the above, the above discussed male part (also referred to as a projection and/or a hexagonal shaft) can be either entirely or partially comprised of elastic materials. The elasticity of the material facilitates the engagement of the male part with the female part (also referred to as a recess and/or a hole).

1-12. (canceled)

13. A rotating part installable in an image forming apparatus, comprising:
a drive transmission member including a ratchet type male part configured to be inserted into a twisted triangular female part, the male part including a plurality of wedges extending from a base surface, and the wedges arranged to contact the female part at an edge or surface and not at a point thereof.

14. The rotating part according to claim 13, wherein the wedges have respective inner and outer side profiles respectively corresponding to inner and outer radial position of the rotating part, the inner side profiles having a larger circumferential dimension relative to the outer side profiles so as to increase an amount of material of the male part engageable with the female part.

15. The rotating part according to claim 14, wherein the wedges each includes a contact surface which extends between corresponding edges of the inner and outer side profiles thereof, the contact surface configured to have a complementary contour to that of a corresponding contact surface of the female part.

16. The rotating part according to claim 13, wherein the wedges have respective inner and outer curved edges corresponding to inner and outer radial positions of the rotating part.

17. A rotating part installable in an image forming apparatus, comprising:
a drive transmission member including a ratchet-type male part configured to be inserted into a twisted triangular female part, the male part including a plurality of wedges extending from a base surface, and the wedges having respective inner and outer curved edges corresponding to inner and outer radial positions of the rotating part.
